(19) United States
(12) Patent Application Publication
(10) Pub. No.: US 2015/0301270 A1
(43) Pub. Date: Oct. 22, 2015

(54) DISPLAY DEVICE PROVIDED WITH A LIGHT GUIDE

(71) Applicant: DELPHI TECHNOLOGIES, INN., TROY, MI (US)

(72) Inventors: YANNICK MOLARD, HERSBACH (FR); EMMANUEL CORDIER, GRENDELBRUCH (FR)

(21) Appl. No.: 14/424,050

(22) PCT Filed: Aug. 26, 2013
(86) PCT No.: PCT/EP2013/067651

§ 371 Date: Feb. 26, 2015

(30) Foreign Application Priority Data
Aug. 30, 2012 (FR) 1258103

(51) Int. Cl. F21V 8/00; B60K 35/00; G06F 3/041

(52) U.S. Cl. CPC G02B 6/0068; G06F 3/041; B60K 35/00; G02B 6/0073; B60K 2350/106; B60K 2350/203

(57) ABSTRACT

A display device that includes a housing in which is arranged a display within a display window delimited by a peripheral edge. The housing is provided with at least one light guide associated with at least one light source. The light guide includes a first portion which is arranged outside the peripheral edge and which produces a lateral illuminating beam outside the peripheral edge, and a second portion which extends as an extension of the first portion into the display window, and which produces an auxiliary illuminating beam in the display window.

### CROSS-REFERENCE TO RELATED APPLICATION

This application claims the benefit under 35 U.S.C. §371 of published PCT Patent Application Number PCT/EP 2013/067651, filed Aug. 26, 2013 and claims priority to French Patent Application 1258103 filed Aug. 30, 2012, and published as WO2014/033096 Mar. 6, 2014, the entire contents of which is hereby incorporated by reference herein.

### TECHNICAL FIELD OF INVENTION

The present invention relates to a display device in particular provided to be arranged in the passenger compartment of an automobile vehicle.

### BACKGROUND OF INVENTION

The present invention relates more particularly to a display device comprising a housing in which is arranged a display and comprising control buttons such as those which are arranged on the dashboard of an automobile vehicle. The display is for example a liquid crystal display, of rectangular shape. An example of a display device is disclosed in document DE102008048448A1. The dimensions of the display, in particular the length of its diagonal, have a great influence on the cost of the display device. The longer the diagonal, the higher the cost of the display device.

The present invention aims to propose a solution which makes it possible to extend the display zone while minimising the dimensions of the display. It also aims to improve the ergonomics of the display device economically.

### SUMMARY OF THE INVENTION

With this aim, the invention proposes a display device, in particular for an automobile vehicle, comprising a housing in which is arranged a display within a display window delimited by a peripheral edge, characterised in that the housing is provided with at least one light guide associated with at least one light source, the light guide comprising:

a first portion which is arranged outside the peripheral edge and which produces a lateral illuminating beam outside the peripheral edge, and

a second portion which extends as an extension of the first portion into the display window, and which produces an auxiliary illuminating beam in the display window.

The display device according to the invention makes it possible to improve the perceived quality and to simulate the presence of a larger display than the one which is actually mounted in the housing. Light guides make it possible to obtain customizable surface effects and lighting effects as a function of the information displayed on the display, which improves the ergonomics of the display device.

The continuity of the light guide from the lateral window to the interior of the display window makes it possible to produce an effect of enlarging the display without increasing the cost of the electronic part of the display. This also allows a great variety of lighting effects which contribute to the ergonomics of the display device.

The arrangement of the light guide according to the invention also makes it possible to produce an effect of depth in the display function, simulating display in three dimensions, at low cost. The user can thus more easily recognise the different functions on the display.

According to other advantageous characteristics of the invention:

the second portion of the light guide extends between the display window and the display;

the light guide is produced by moulding with the adjacent wall of the housing;

the housing comprises a lateral window which is separate from the display window, and at least a part of the first portion of the light guide is arranged within the lateral window so as to emit the lateral illuminating beam through the lateral window;

the lateral window has an elongate shape which extends substantially parallel to the adjacent edge of the display window;

the lateral window comprises a device for the detection of touch so as to constitute a touch-controlled switch;

each portion of the light guide comprises rough surfaces provided for producing the corresponding illuminating beam;

the thickness of the second portion of the light guide decreases progressively with the distance from the peripheral edge;

a printed circuit board is arranged in the housing and the light source consists of a light-emitting diode which is mounted on the printed circuit board;

the display zone of the display is substantially equal to the area of the display window, so that the lateral illuminating beam is emitted outside said display zone;

at least two light guides are provided, which are arranged symmetrically on either side of the display.

### BRIEF DESCRIPTION OF DRAWINGS

Further characteristics, aims and advantages of the invention will be apparent on reading the detailed description below, and with reference to the attached drawings, given as an example to which it is not limited, and in which:

FIG. 1 is a front view which shows schematically the front surface of a display device realised according to the instructions of the invention; and

FIG. 2 is a view in axial section along plane 2-2 which shows schematically the display device of FIG. 1.

### DETAILED DESCRIPTION

In the remainder of the description, similar or identical components may be designated by the same reference signs.

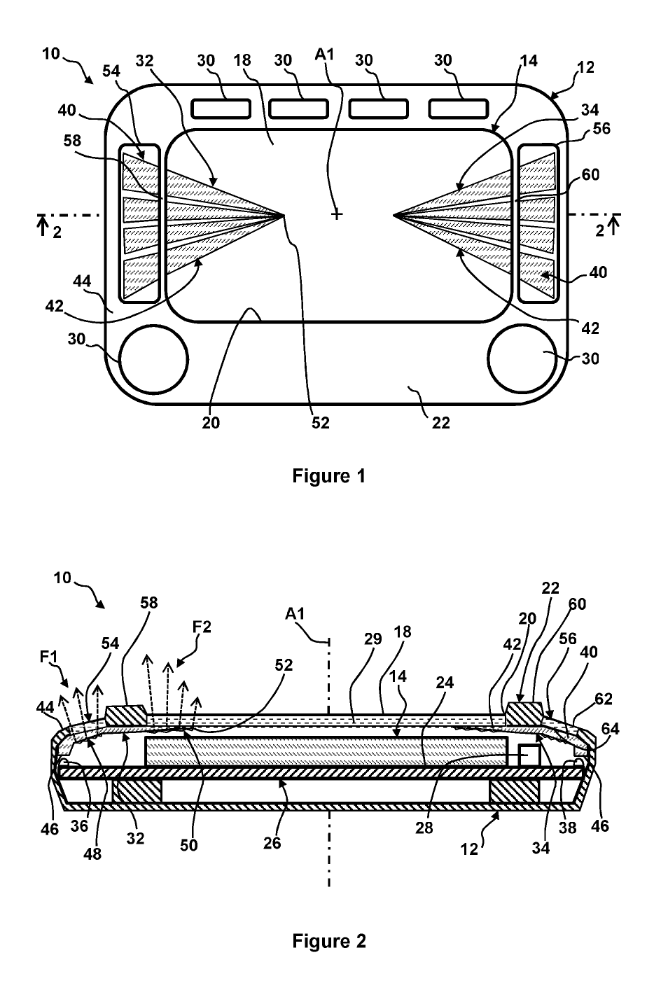

In FIGS. 1 and 2 has been shown a display device 10 provided to be arranged in the passenger compartment of an automobile vehicle (not shown). The display device 10 comprises a housing 12 in which is arranged a display 14.

In the remainder of the description a longitudinal direction Al oriented from front to back which corresponds to a direction orthogonal to the display 14 and which corresponds to an orientation from top to bottom, looking at FIG. 2, will be used, without being limited to this.

The display 14 here has the form of a generally rectangular display tile which is arranged within the housing 12, within and behind a display window 18 delimited by a peripheral edge 20 in the front surface 22 of the housing 12. The display 14 consists for example of a liquid crystal or light-emitting diode display. It is here mounted on the front surface 24 of a printed circuit board 26 and controlled by an electronic control unit 28 arranged on the printed circuit board 26. The display 14 has a display zone, or maximum display area, which generally corresponds to the area of the display window 18. The display window 18 preferably includes a protective glass panel 29. The protective glass 29 or the display 14 can be provided with a device for the detection of touch for the purpose of making the display 14 tactile in order to allow touch control of certain functions.

According to the embodiment shown, the housing 12 is provided with switches 30 for the purpose of controlling different functions of the vehicle such as air conditioning, car radio, navigation system, etc. The switches 30 can consist of touch-sensitive surfaces, or tactile surfaces, or mechanically activated switches.

According to the teaching of the invention, the housing 12 is provided with at least one light guide 32, 34 associated with at least one light source 36, 38. According to the embodiment shown here, it comprises a first light guide 32 arranged on the left side of the display 14, and a second light guide 34 on the right side of the display 14, looking at FIGS. 1 and 2.

Each light guide 32, 34 comprises a first portion 40 which is arranged outside the peripheral edge 20 and which produces a lateral illuminating beam F1 outside the peripheral edge 20, and a second portion 42 which extends, as an extension of the first portion 40, within the peripheral edge 20, and which produces an auxiliary illuminating beam F2 in the display window 18, above the display 14.

Each light guide 32, 34 is in the form of at least one translucent plastic strip which extends partly against the inner surface of the front wall 44 of the housing 12. Preferably, this translucent plastic strip is produced by moulding, or over-molding, with the front wall 44 of the housing 12, for example made of polycarbonate.

Each light guide 32, 34 comprises at least one light input surface 46 which is arranged proximate to the associated light source 36, 38. The light source 36, 38 is here a light-emitting diode arranged on the front surface 24 of the printed circuit board 26. Naturally, the light guide 32, 34 may comprise several input surfaces 46 for several light sources 36, 38.

To produce the illuminating beams Fl, F2, the light guides 32, 34 are provided with light-diffusing elements consisting for example of rough surfaces 48, 50 arranged on the walls of the first 40 and second 42 portions. These rough surfaces 48, 50 form refracting microfacets which allow the light which has entered the light guide 32, 34 by the input surface to exit from the light guide 32, 34 at given locations situated on the first 40 and second 42 portions.

Advantageously, the thickness of the strip forming the light guide 32, 34 decreases progressively up to the free end 52 of the second portion 42. The thickest part is here situated at the level of the input surface 46, and the thinnest part is situated at the free end 52 of the second portion 42. The combination of the thinness of the second portion 42 and adapted distribution of the rough surfaces 48, 50 on the second portion 42 make it possible to obtain an auxiliary light beam of which the luminous intensity decreases progressively on approaching the centre of the display window 18 (moving away from the peripheral edge 20).

The housing 12 here comprises first 54 and second 56 lateral windows which are each separated from the display window 18 by a lateral upright 58, 60 arranged along a lateral portion of the peripheral edge 20. The first portion 40 of each light guide 32, 34 extends under the corresponding lateral window 54, 56 so that the lateral illuminating beam F1 is emitted through said lateral window 54, 56.

The lateral windows 54, 56 comprise for example a protective lateral glass panel 62 of a type similar to the protective glass 29 arranged in the display window 18. Preferably, each lateral window 54, 56 has an elongate shape which extends parallel to the adjacent edge of the display window 18. Each lateral window 54, 56 here comprises a device for the detection of touch 64 so as to constitute a touch-controlled switch. This detection device may consist of a translucent film provided with resistive or capacitive sensors carried by the associated protective lateral glass 62. The lateral windows 54, 56 thus form tactile surfaces on either side of the display window 18, and for example allow the user to control cursors displayed on the display 14, along the associated uprights 58, 60, by sliding a finger over the lateral window 54, 56, along the associated upright 58, 60.

According to the embodiment shown, each light guide 32, 34 comprises several strips which extend transversely from the lateral window 54, 56 until they meet while narrowing in the display window 18.

1. A display device suitable for use in an automobile vehicle, said display device comprising:
a housing that defines a display window delimited by a peripheral edge;
a display arranged within the display window; and
at least one light guide associated with at least one light source, wherein the light guide includes
a first portion which is arranged outside the peripheral edge and which produces a lateral illuminating beam outside the peripheral edge, and
a second portion which extends as an extension of the first portion into the display window, and which produces an auxiliary illuminating beam in the display window, wherein the second portion of the light guide extends between the display window and the display.

2. The display device according to claim 1, wherein the light guide is produced by molding with the adjacent wall of the housing.

3. The display device according to claim 1, wherein the housing comprises a lateral window which is separate from the display window, and in that at least a part of the first portion of the light guide is arranged proximate to the lateral window so as to emit the lateral illuminating beam through the lateral window.

4. The display device according to claim 3, wherein the lateral window has an elongate shape which extends substantially parallel to the adjacent edge of the display window.

5. The display device according to claim 3, wherein the lateral window comprises a device for the detection of touch so as to constitute a touch-controlled switch.

6. The display device according to claim 1, wherein each portion of the light guide comprises rough surfaces provided for producing the corresponding illuminating beam.

7. The display device according to claim 1, wherein the thickness of the second portion of the light guide decreases progressively with the distance from the peripheral edge.

8. The display device according to claim 1, wherein a printed circuit board is arranged in the housing and in that the light source consists of a light-emitting diode which is mounted on the printed circuit board.

9. The display device according to claim 1, wherein the display zone of the display is substantially equal to the area of the display window, so that the lateral illuminating beam is emitted outside said display zone.

10. The display device according to claim 1, wherein the display device comprises at least two light guides which are arranged symmetrically on either side of the display.
